(19) United States
(12) Patent Application Publication
(10) Pub. No.: US 2023/0039695 A1
(43) Pub. Date: Feb. 9, 2023

(54) Soft Baked Snack and Methods of Making

(71) Applicant: General Mills, Inc., Minneapolis, MN (US)

(72) Inventors: Jessica Chatziyakoumis, Logrono, La Rioja (ES); Michelle M Manderfeld, Plymouth, MN (US); Sara Rosene, New Hope, MN (US); Katie Wanner, Minneapolis, MN (US); Natasha Weatherby, Minneapolis, MN (US)

(73) Assignee: General Mills, Inc., Minneapolis, MN (US)

(21) Appl. No.: 17/791,003

(22) PCT Filed: Jan. 7, 2021
(86) PCT No.: PCT/US2021/012397

§ 371 Date: Jul. 6, 2022

Related U.S. Application Data
(60) Provisional application No. 62/958,375, filed on Jan. 8, 2020.

(51) Int. Cl. A21D 13/064; A21D 13/045; A21D 2/26; A21D 2/18; A23P 30/20

(52) U.S. Cl. CPC A21D 13/064; A21D 13/045; A21D 2/263; A21D 2/266; A21D 2/268; A21D 2/181; A23P 30/20

(57) ABSTRACT

A soft baked snack including a high protein matrix and particulates that retains a soft, moist eating experience over an extended shelf life is described. The high protein matrix includes collagen, a hydrolyzed dairy protein, a structural protein, and structure setting protein to achieve a desired eating experience. Methods of making a soft baked snack are also disclosed.

### BACKGROUND

Consumers are increasingly looking for foods that meet their nutritional needs without requiring preparation. Shelf stable baked snack items are a category of ready-to-eat foods that can be challenging to make fit both nutritional needs and a desired eating experience. High protein ready to eat foods suffer from dry texture, poor flavor, and hardening over shelf life. This is particularly true of soft baked snacks, where poor texture and hardening are more pronounced than in products such as crunchy cookies, crackers, or candy bar-like foods. Thus, there is a need for good-tasting ready-to-eat products that meet desired nutritional needs and retain a desirable eating experience over shelf life.

### SUMMARY

The present disclosure relates to a high protein soft baked snack that retains a soft, moist eating experience over shelf life.

Provided herein are soft baked snacks having a stable texture over a shelf life of at least 3 months. A soft baked snack includes a matrix in an amount of 65-90% by weight of the soft baked snack and particulates in an amount of 10% to 35% by weight of the soft baked snack. The matrix includes protein in an amount of 8% to 20% by weight of the soft baked snack, syrup in an amount of from 15% to 30% by weight of the soft baked snack, dry sugar in an amount of from 5% to 15% by weight of the soft baked snack, and fat in an amount of from 10% to 20% by weight of the soft baked snack. Protein in a matrix of a soft baked snack provided herein includes collagen in an amount of from 0.3% to 7% by weight of the soft baked snack, hydrolyzed dairy protein in an amount of from 0.3% to 5% by weight of the soft baked snack, structural protein in an amount of from 5% to 20% by weight of the soft baked snack, and structure setting protein in amount of up to 5% by weight of the soft baked snack, where the ratio of the combined collagen amount and hydrolyzed dairy protein amount to the combined structural protein amount and structure setting protein amount is from 1:1 to 1:3. Syrup in the matrix of a soft baked snack provided herein includes at least one carbohydrate syrup and glycerin.

In some embodiments, a soft baked snack provided herein can have a structural protein that includes a soy protein in an amount of up to 12% by weight of the soft baked snack, calcium caseinate in an amount of up to 8% by weight of the soft baked snack, or a combination thereof.

In some embodiments, a soft baked snack provided herein can have a structure setting protein that includes egg white.

In some embodiments, a soft baked snack provided herein can have a syrup that includes a fiber, such as inulin or soluble corn fiber.

In some embodiments, a soft baked snack provided herein can include glycerin in an amount of from 4% to 15% by weight of the soft baked snack.

In some embodiments, a soft baked snack provided herein can include a fat that includes a shortening. In some embodiments, the fat can include shortening and an oil.

Also provided herein are methods of making a soft baked snack. A method includes providing a dough having a moisture content of from 11% to 22%, forming the dough to produce formed dough; and baking the formed dough to a moisture content of from 7% to 16%. The dough includes protein in an amount of at least 12% by weight of the dough, syrup in an amount of from 15% to 30% by weight of the dough, the syrup including at least one carbohydrate syrup and glycerin, dry sugar in an amount of from 5% to 15% by weight of the dough, where the ratio of the amount of dry sugar to the amount of at least one carbohydrate syrup is from 1:1 to 3:1, fat in an amount of from 10% to 20% by weight of the dough, and particulates in an amount of 10% to 35% by weight of the dough. The protein in the dough includes collagen in an amount of from 0.3% to 7% by weight of the dough, hydrolyzed dairy protein in an amount of from 0.3% to 5% by weight of the dough, structural protein in an amount of from 5% to 20% by weight of the dough, and structure setting protein in amount of up to 5% by weight of the dough, where the ratio of the combined collagen and hydrolyzed dairy protein amounts to the combined structural protein and structure setting protein amounts is from 1:1 to 1:3.

In some embodiments, a method provided herein can include a step of producing the dough using, for example, a continuous process.

In some embodiments of a method provided herein, the dough can be formed by extrusion.

### BRIEF DESCRIPTION OF DRAWINGS

FIG. 1 is a graph of sensory traits for an embodiment of an inventive high protein soft bake snack over an accelerated shelf life.

FIG. 2 is a graph of sensory traits for a high protein soft baked snack that does not contain collagen over an accelerated shelf life.

FIG. 3 is a graph of sensory traits for a high protein soft baked snack that does not contain collagen or a hydrolyzed dairy protein over an accelerated shelf life.

FIG. 4 is a graph of sensory traits for a commercially available high protein soft baked snack that does not contain collagen or hydrolyzed dairy protein over an accelerated shelf life.

FIG. 5 is a graph of sensory traits for a commercially available high protein soft baked snack that does not contain collagen or hydrolyzed dairy protein over an accelerated shelf life.

FIG. 6 is a graph of sensory traits for a commercially available high protein chewy bar that does not contain collagen or hydrolyzed dairy protein over an accelerated shelf life.

### DETAILED DESCRIPTION

Consumers often look for convenient foods that fit a desired nutritional profile. High protein content fits one such nutritional profile. However, including high amounts of protein in many convenient, shelf stable foods can result in textures or flavors that are off-putting, and can lead to hardening and/or drying over shelf life. Further, the drying effect of high protein content can lead to difficulty achieving a texture that resembles a soft baked snack rather than a crispy or hard cookie.

The inventors of the present application were tasked with producing a high protein (e.g., at least 12%, at least 14%, or at least 16% protein by weight) soft baked snack with good flavor, good texture, a desired perceived moistness, and texture and perceived moisture stability over shelf life. In some embodiments, protein content in a soft baked snack provided herein can provide at least 15% (e.g., at least 17%, or at least 19%) of the caloric content of the soft baked snack.

It was discovered, and is described herein, that a particular combination of proteins, syrup, dry sugar, fat and particulates can achieve a soft baked snack product that imparts good flavor and texture, and does not significantly harden or develop a dry eating experience over shelf life. In addition, a soft baked snack provided herein can advantageously be readily manufactured using standard equipment. For example, a dough used to make a soft baked snack including the particularly described combinations of ingredients in the described amounts can advantageously be extruded using standard equipment.

As used herein, the term “soft baked snack” refers to food that is baked from a dough or batter to achieve a finished product moisture of 7 to 16% (e.g., 8 to 15%, or 9% to 14%), with a soft texture and a crumb structure reminiscent of cake, brownies, or soft cookies. Such a soft baked snack does not resemble crunchy or hard cookies, hard biscuits, or crackers, which typically have a moisture content of 5% or less. Nor does such a soft baked snack resemble confections, such as nougat or caramel, which typically do not have a crumb structure, and are not baked. Surprisingly, even though soft baked snack texture is typically associated with the inclusion of flour, a soft baked snack provided herein can deliver such a texture, even with little or no flour content.

A soft baked snack provided herein has a stable texture and perceived moistness over a packaged shelf life of at least 3 months (e.g., at least 5 months, or at least 8 months).

The soft baked snack provided herein includes a matrix in an amount of 65% to 90% by weight of the soft baked snack, with particulates in an amount of 10% to 35% by weight of the soft baked snack distributed throughout the matrix. The matrix of a soft baked snack includes protein in an amount of 8% to 20% (e.g., 10% to 18%, or 11% to 15%) by weight of the soft baked snack.

Protein in the matrix of a soft baked snack includes collagen, hydrolyzed dairy protein, structural protein, and structure setting protein.

Collagen in included in the matrix of a soft baked snack in an amount of from 0.3% to 7% (e.g., 0.5% to 5%, or 2% to 4%) by weight of the soft baked snack. In some embodiments, collagen can comprise hydrolyzed collagen. In some cases, a collagen suitable for use in a soft baked snack provided herein can be referred to as collagen peptide. Collagen can contribute to a texture that is perceived as moist and soft, rather than brittle and dry. Collagen can also contribute to maintaining soft texture, moist eating experience, and cohesiveness over shelf life. Lack of sufficient collagen can result in product over shelf life that develops a dry eating experience and a structure that fractures or disintegrates upon biting rather than remaining cohesive and soft. Amounts of collagen above 7% by weight of a soft baked snack can contribute to a poor flavor. Collagen can also impact spread of a dough used to make a soft baked snack provided herein, which can impact the dimensions, and subsequent manufacturability, of a soft baked snack provided herein. Generally, as collagen is increased in a dough used for making a soft baked snack, the dough is more likely to spread further across a surface, thus impacting the dimensions of a soft baked snack made from such a dough.

Hydrolyzed dairy protein is included in the matrix of a soft baked snack in an amount of from 0.3% to 5% (e.g., 0.5% to 4%, or 1% to 3%) by weight of the soft baked snack. Hydrolyzed dairy protein can contribute to a texture that is perceived as moist and soft, rather than hard and dry. Hydrolyzed dairy protein can also contribute to maintaining soft texture over shelf life. Amounts of hydrolyzed dairy protein above 5% by weight of a soft baked snack can contribute to a poor flavor. Hydrolyzed dairy protein can also impact spread of a dough used to make a soft baked snack provided herein, which can impact the dimensions, and subsequent manufacturability, of a soft baked snack provided herein. Generally, as hydrolyzed dairy protein is increased in a dough used for making a soft baked snack, the dough is more likely to spread further across a surface, thus impacting the dimensions of a soft baked snack made from such a dough.

Inclusion of both collagen and hydrolyzed dairy protein can provide benefits to texture, cohesiveness, and perceived moisture. Insufficient amounts of a combination of collagen and hydrolyzed dairy protein can result in product over shelf life that develops a dry eating experience and a structure that is hard, and fractures or disintegrates upon biting rather than remaining cohesive and soft. Insufficient amounts of a combination of collagen and hydrolyzed dairy protein can result in a dough that is difficult to extrude using standard equipment.

A structural protein is included in the matrix of a soft baked snack in an amount of 5% to 20% (e.g., 5% to 15%, or 7% to 12%) by weight of the soft baked snack. As used herein, a structural protein refers to a protein or blend of proteins that provides bulk to a soft baked snack without significantly binding moisture in the structure. A structural protein can help contribute to a soft texture and/or crumb structure that is not dry and prevent hardening over shelf life. Suitable structural proteins include, for example, vegetable protein (e.g., soy protein and pea protein), and dairy protein (e.g., calcium caseinate, whey protein, and milk protein).

In some embodiments, soy protein can be included in the matrix of a soft baked snack in an amount of up to 12% (e.g., 2% to 10%, or 5% to 8%) by weight of the soft baked snack. Amounts of soy protein above 12% by weight of a soft baked snack can contribute to a poor flavor, a texture that is too firm or hard, or a texture that is perceived as dry. Soy protein can also impact moistness of a dough used to make a soft baked snack provided herein. Soy protein content above 12% by weight of a soft baked snack can also contribute to reduced shelf life due to changes in texture, such as increased dryness, increased tendency to become too crumbly, and/or increased perceived astringency.

In some embodiments, calcium caseinate can be included in the matrix of a soft baked snack in an amount of up to 8% (e.g., 1% to 5%, or 2% to 4%) by weight of the soft baked snack. Amounts of calcium caseinate above 8% by weight of a soft baked snack can contribute to a poor flavor, a texture that is too firm or hard, a texture that is perceived as dry, or a texture that crumbles too readily. Calcium caseinate can also impact moistness of a dough used to make a soft baked snack provided herein. Calcium caseinate content above 8% by weight of a soft baked snack can also contribute to reduced shelf life due to changes in texture, such as increased dryness and/or increased tendency to become too crumbly.

In some embodiments, a structure setting protein can be included in the matrix of a soft baked snack in an amount of up to 5% (e.g., 0.5% to 4%, or 1% to 3%) by weight of the soft baked snack. As used herein, a structure setting protein refers to a protein that denatures and/or crosslinks relatively early in the baking process of making a soft baked snack. Suitable structure setting proteins include, for example, egg white, chickpea liquid, and gelatin.

The matrix of a soft baked snack can have a ratio of the combined amounts of collagen and hydrolyzed dairy protein (amount of collagen+amount of hydrolyzed dairy protein) to the combined amount of structural protein and structure setting protein (amount of structural protein+amount of structure setting protein) of from 1:1 to 1:3 (e.g., about 1:2). Such a ratio surprisingly provides the desired soft baked snack texture, with textural stability over shelf life.

The matrix of a soft baked snack provided herein also includes syrup in an amount of from 15% to 30% (e.g., 17% to 27%, or 20% to 25%) by weight of the soft baked snack. As used herein, “syrup” refers to a viscous liquid food ingredient with a moisture content of less than 35% (e.g., 30% or less). Syrup in a soft baked snack provided herein includes glycerin and at least one carbohydrate syrup. In some embodiments, a matrix of a soft baked snack provided herein can include glycerin in an amount from 2% to 15% (e.g., 3% to 12%, or 7% to 10%) by weight of the soft baked snack.

Suitable carbohydrate syrups include, for example, sugar syrups (e.g., honey, fruit juice concentrates, molasses, maple syrup, tapioca syrup, corn syrup, and the like), fiber syrups (e.g., inulin, soluble corn fiber, fructooligosaccharides, polydextrose, β-glucan, isomalto-oligosaccharides, galacto-oligosaccharides, arabinoxylans, and the like), non-glycerin sugar alcohols (e.g., maltitol, sorbitol, isomalt, mannitol, polyglycitol syrups, lactitol, erythritol, xylitol, and the like), and the like (e.g., allulose), and combinations thereof.

The matrix of a soft baked snack provided herein also includes dry sugar in an amount of from 5% to 15% (e.g., 7% to 13%, or 8% to 12%) by weight of the soft baked snack. As used herein, “dry sugar” refers to a solid sugar rather than a syrup. Suitable sugars can be flaked, granulated, powdered, or the like. Dry sugar can include sugars (e.g., sucrose, fructose, and the like) and sugar alcohols (e.g., erythritol).

The matrix of a soft baked snack can have a ratio of the amount of carbohydrate syrup to the amount of dry sugar of from 1:1 to 3:1 (e.g., about 2:1). Such a ratio can contribute to a texture that is perceived as moist and soft. Such a ratio can also contribute to improved dough handling attributes of a dough used to make a soft baked snack described herein.

The matrix of a soft baked snack provided herein includes fat in an amount of from 10% to 20% (e.g., 12% to 18%, or 13% to 17%) by weight of the soft baked snack. Suitable fats can be either solid or liquid at room temperature. Suitable fats include, without limitation, palm shortening, canola oil, peanut oil, soybean oil, coconut oil, cottonseed oil, lard, olive oil, butter, and the like, and any combination thereof. A fat can contribute to a soft texture in a soft baked snack provided herein. In some embodiments, a fat can impact spread of a dough used to make a soft baked snack provided herein, which can impact the dimensions of a soft baked snack provided herein.

Particulates in a soft baked snack provided herein are included in an amount of from 10% to 35% (e.g., 15% to 35%, or 25% to 32%) by weight of the soft baked snack. Particulates can aid in the formation of a crumb structure of a soft baked snack by interrupting the matrix structure of the soft baked snack. Suitable particulates include, for example, protein crisps, protein bits or nuggets, puffed grain, rolled oats, grain kernels or grain kernel pieces, nuts or nut pieces, dried fruit pieces, confection pieces, and the like, or any combination thereof.

In some embodiments, particulates can be selected based on nutritional content. For example, protein crisps can be used to increase total protein content of a soft baked snack. In some embodiments, particulates in a soft baked snack can contribute protein in an amount of at least 2% (e.g., 3% to 12%, or 4% to 10%) by weight of the soft baked snack.

In some embodiments, particulates can be selected based on moisture absorption properties of the particulates. For example, particulates with low absorption properties can be selected to reduce drying over shelf life. In another example, particulates with moderate absorption properties can be selected to increase firmness in a dough used to make a soft baked snack provided herein.

In some embodiments, additional ingredients can be included in a soft baked snack. Additional ingredients can include, without limitation, leavening agents, flavorants, colorants, flour, salt, spices, cocoa powder, and the like.

Methods of making a soft baked snack are provided herein. A method includes combining ingredients to achieve a dough having a moisture content of 11% to 22% (e.g., 15% to 22%), and having the ingredients described above in the described amounts. In some embodiments, water can be added to the ingredients to achieve a dough with the desired moisture content. In some embodiments, sufficient water is included in the ingredients (e.g., from syrups) to achieve the desired moisture content of the dough. A dough suitable for making a soft baked snack provided herein can thus have a moisture content of 11% to 22%, protein in an amount of 12% to 20% by weight of the dough, the protein including collagen in an amount of 0.3% to 7% by weight of the dough, hydrolyzed dairy protein in an amount of 0.3% to 5% by weight of the dough, structural protein in an amount of 5% to 20% by weight of the dough, structure setting protein in an amount of up to 5% by weight of the dough, syrup in an amount of 15% to 30% by weight of the dough, dry sugar in an amount of 5% to 15% by weight of the dough, fat in an amount of 10% to 20% by weight of the dough, and particulates in an amount of 10% to 35% by weight of the dough.

A dough can be made using any appropriate method, including batch mixing or a continuous process. A dough can then be formed to produce a formed dough, and then the formed dough can be baked to a moisture content of 7% to 16% (e.g., 8 to 15%, or 9% to 14%) to form a soft baked snack as described herein. A dough including the described ingredients at the described amounts and ratios is particularly suited to high throughput formation by extrusion onto a surface because it does not spread too quickly over the surface, but it can also be formed using other methods, such as in a mold.

A soft baked snack provided herein can be packaged in any suitable packaging, including single serving and multi-serving packages. In some embodiments, packaging that resists moisture transfer and/or oxygen transfer into or out of the packaging can be used.

The implementations described above and other implementations are within the scope of the following claims. One skilled in the art will appreciate that the present disclosure can be practiced with embodiments other than those disclosed.

The following examples are presented for purposes of illustration and not limitation.

### EXAMPLES

### Example 1

Soft baked bars were made according to the formulas in Table 1. In the variant (V1, V2, V3, and V4) columns, the ingredients remained the same as in control, except where indicated. Structural protein included one or more of soy protein and calcium caseinate. Structure setting protein included egg white. The ratio of the combined collagen+hydrolyzed dairy protein to combined structural protein+structure setting protein was 1:1 to 1:3 in all samples. Syrup included glycerin and a combination of inulin syrup, fruit juice concentrate, tapioca syrup, and honey. Dry sugar included sucrose and fructose. Fat included a shortening and an oil. Other ingredients were included in an amount of about 8-9% of the matrix, and included in the control sample 5-6% of the matrix as flour, 0.2-0.5% of the matrix as leavening agent, and minor amounts of flavorants. Particulates included soy protein crisps, flaked and/or rolled grains, dried fruit, and nuts. With the exception of V2, where the removed portion of the syrup was replaced with water, ingredients that were removed were not replaced with any other component.

TABLE 1

| | Ingredient (by | | | | | |
|---|---|---|---|---|---|---|
| Component | total weight) | Control | V1 | V2 | V3 | V4 |
| Matrix | Protein, total | 8-20% | | | | |
| | Collagen | 0.3-7% | | | | |
| | Hydrolyzed | 0.3-5% | | | | |
| | dairy protein | | | | | |
| | Structural | 5-20% | | | | |
| | protein | | | | | |
| | Structure | 0.1-5% | | | | |
| | setting protein | | | | | |
| | Syrup | 15-30% | 10-12% | 10-12%, | | |
| | | | | water | | |
| | | | | replacement | | |
| | | | | of balance | | |
| | Dry sugar | 5-15% | | | | |
| | Fat | 10-20% | | | | |
| | Other | | | | 0% | 0% |
| | | | | | flour | leavener |
| Particulates | | 10-35% | | | | |

Upon baking, V3 and V4 were very similar to control, with V3 exhibiting spreading only slightly more than control, indicating that flour and leavener are not essential to texture or manufacturing benefits. V2 spread significantly, and while V1 behaved similarly to control for spreading, it exhibited a harder texture. This suggests that the amount of syrup in the control provides texture and manufacturability benefits.

### Example 2

Soft baked bars were made according to the formulas in Table 2. In variant 5 (V5), the ingredients remained the same as control, except that collagen was removed and an equivalent amount of structural protein was used to replace it. In variant 6 (V6), the ingredients remained the same as control, except that collagen and hydrolyzed dairy protein were removed and an equivalent amount of structural protein was used to replace them. Structural protein included soy protein and calcium caseinate. Structure setting protein included egg white. The ratio of the combined collagen+hydrolyzed dairy protein to combined structural protein+structure setting protein was 1:1 to 1:3 in the control sample. Syrup included glycerin and a combination of inulin syrup, fruit juice concentrate, honey, glucose syrup, and molasses. Dry sugar included sucrose and fructose. Fat included a shortening and an oil. Other ingredients were included in an amount of about 9-11% of the matrix, and included flour, leavening agent, and minor amounts of flavorants and water. Particulates included soy protein crisps and flaked and/or rolled grains. It was noted that the dough for V5 and V6 were both very firm, and were difficult to extrude compared to control.

TABLE 2

| | Ingredient (by total | | | |
|---|---|---|---|---|
| Component | weight) | Control | V5 | V6 |
| Matrix | Protein, total | 8-20% | | |
| | Collagen | 0.3-7% | 0% | 0% |
| | Hydrolyzed dairy | 0.3-5% | | 0% |
| | protein | | | |
| | Structural protein | 5-20% | 10-20% | 10-20% |
| | Structure setting | 2-5% | | |
| | protein | | | |
| | Syrup | 15-30% | | |
| | Dry sugar | 5-15% | | |
| | Fat | 10-20% | | |
| | Other | | | |
| Particulates | | 10-35% | | |

The samples from Table 2 were baked at 350° F. for 9 minutes, cooled, and packaged as 38 g weight soft baked bars in individual packages, and subjected to an accelerated shelf life test alongside commercially available products having similar protein content (individual servings in original packaging). Water activity for control, V5 and V6 prior to accelerated shelf life testing ranged from about 0.35 to about 0.37. Accelerated shelf life testing was performed at humidity controlled conditions at 90° F., with each week in accelerated shelf life conditions approximately equivalent to 3 weeks of shelf life at room temperature. The commercially available products included those described in Table 3. Based on the nutritional label, none of the commercially available products included collagen or hydrolyzed dairy protein.

TABLE 3

| | | Protein content | |
|---|---|---|---|
| | | (% by weight, | |
| | | based on | |
| | | nutritional | |
| Sample | Product | labeling) | Description |
| C1 | Kind Breakfast | 16% | Soft baked bar, 50 g |
| | Protein Bar; almond | | weight, water activity |
| | butter flavor | | about 0.59 |
| C2 | BelVita Protein Soft | 20% | Soft baked biscuit, 50 |
| | Baked Biscuits; oats, | | g weight, water |
| | honey, and chocolate | | activity |
| | flavor | | about 0.62 |
| C3 | Clif Energy Bars; | 13% | Chewy bar, 68 g |
| | oatmeal raisin walnut | | weight, water activity |
| | flavor | | about 0.63 |

Each of the samples from Table 2 and Table 3 were tested using a sensory panel over 8 weeks of accelerated shelf life (equivalent of 6 months standard, room temperature shelf life). Briefly, each sample was removed from accelerated shelf life testing and allowed to equilibrate at room temperature overnight before testing using the sensory panel the next day. Sensory panel testing analyzed the traits in Table 4, with each trait given a score of 1 (does not represent the trait) to 5 (represents the trait to the greatest degree possible).

TABLE 4

| Trait | Description |
|---|---|
| First bite firmness | Force needed to break into the product, |
| | performed with the front teeth |
| Moistness | Perceived wetness or lubricity in the mouth |
| | from the food while chewing |
| Dryness | Dryness, powder, or dusty feeling while |
| | chewing the product |

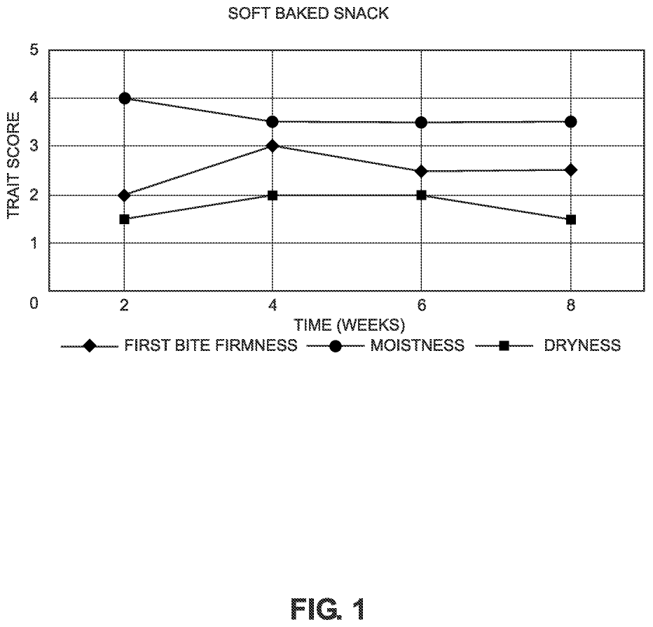

Scores over the 8 week accelerated shelf life are shown in Tables 5-7, and graphed in FIGS. 1-6. Over the 8 week accelerated shelf life testing, control retained the most pleasant eating experience, remaining soft (moderate first bite firmness) and moist. See, FIG. 1.

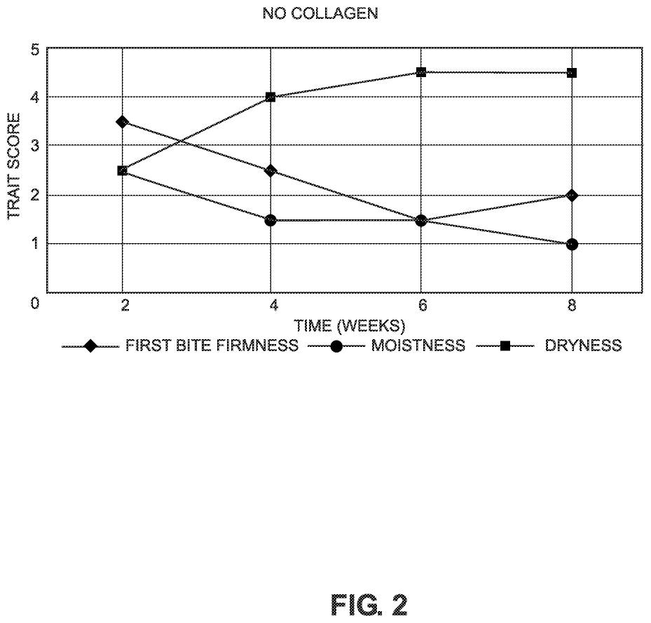

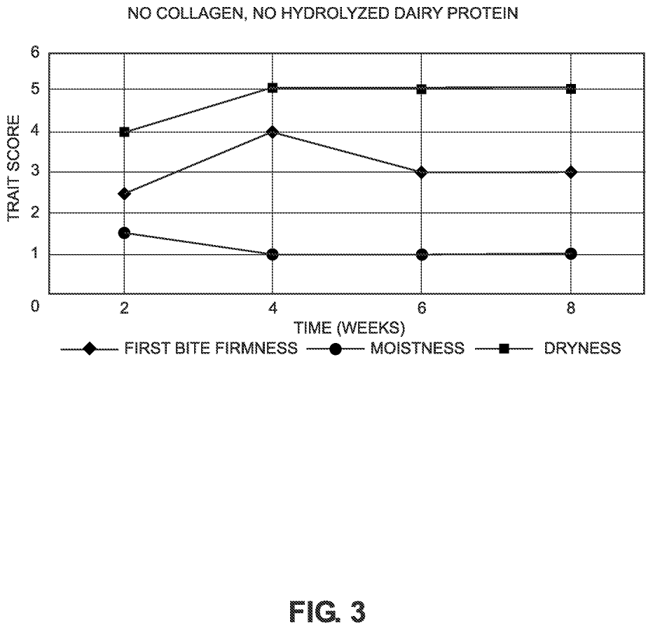

Generally, V5 and V6 became dry and dusty, and more prone to fracture or disintegration rather than compression upon biting, with the particulates also becoming harder over accelerated shelf life. See, FIGS. 2 and 3. V5 maintained a first bite firmness greater than control over accelerated shelf life, while first bite firmness in V6 dropped over accelerated shelf life. See, FIG. 3.

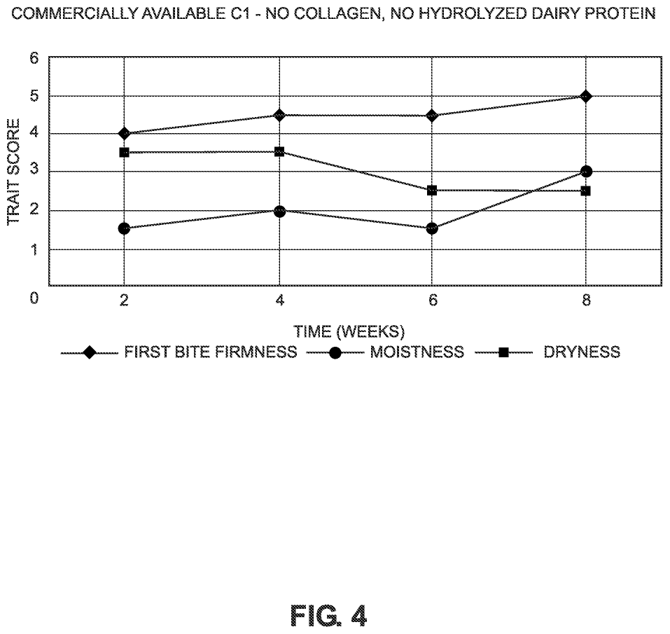

C1 remained significantly more firm than control, and became more crunchy, with increasing dryness over time. See, FIG. 4.

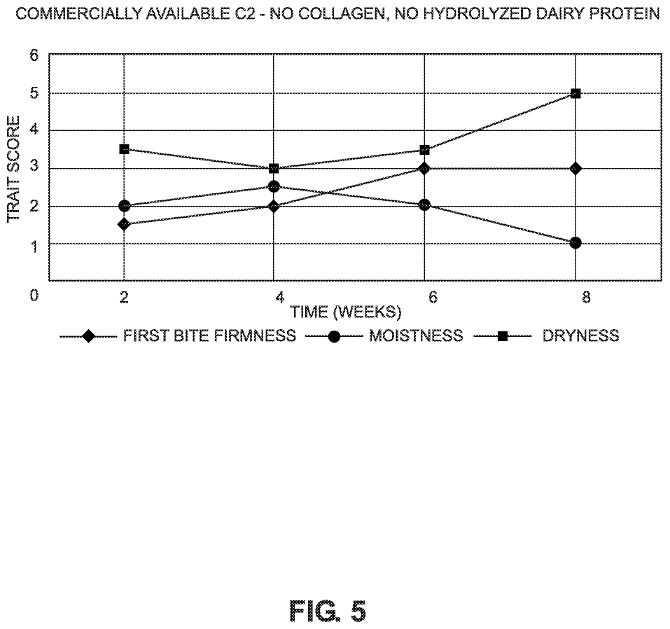

C2 had an initial first bite firmness that was lower than control, but first bite firmness of C2 increased over time. C2 also became dryer over the accelerated shelf life. See, FIG. 5.

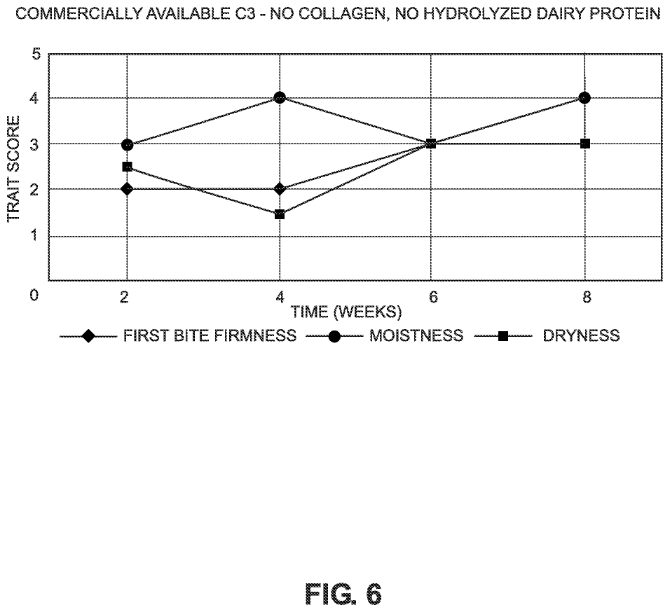

C3 became somewhat firmer over accelerated shelf live, but was relatively steady regarding moisture and dryness. See, FIG. 6. However, C3 exhibited surface dampness and rancidity over accelerated shelf life.

TABLE 5
First Bite Firmness

| Time | | | | | | |
|---|---|---|---|---|---|---|
| (weeks) | Control | V5 | V6 | C1 | C2 | C3 |
| 2 | 2 | 3.5 | 2.5 | 4 | 1.5 | 2 |
| 4 | 3 | 2.5 | 4 | 4.5 | 2 | 2 |
| 6 | 2.5 | 1.5 | 3 | 4.5 | 3 | 3 |
| 8 | 2.5 | 2 | 3 | 5 | 3 | 3 |

TABLE 6
Moistness

| Time | | | | | | |
|---|---|---|---|---|---|---|
| (weeks) | Control | V5 | V6 | C1 | C2 | C3 |
| 2 | 4 | 2.5 | 1.5 | 1.5 | 2 | 3 |
| 4 | 3.5 | 1.5 | 1 | 2 | 2.5 | 4 |
| 6 | 3.5 | 1.5 | 1 | 1.5 | 2 | 3 |
| 8 | 3.5 | 1 | 1 | 3 | 1 | 4 |

TABLE 7
Dryness

| Time | | | | | | |
|---|---|---|---|---|---|---|
| (weeks) | Control | V5 | V6 | C1 | C2 | C3 |
| 2 | 1.5 | 2.5 | 4 | 3.5 | 3.5 | 2.5 |
| 4 | 2 | 4 | 5 | 3.5 | 3 | 1.5 |
| 6 | 2 | 4.5 | 5 | 2.5 | 3.5 | 3 |
| 8 | 1.5 | 4.5 | 5 | 2.5 | 5 | 3 |

1. A soft baked snack having a stable texture over a shelf life of at least 3 months, prepared from a dough comprising:
a. a matrix in an amount of 65-90% by weight of the soft baked snack, the matrix including:
i. protein in an amount of 8% to 20% by weight of the soft baked snack, the protein including:
a) collagen in an amount of from 0.3% to 7% by weight of the soft baked snack,
b) hydrolyzed dairy protein in an amount of from 0.3% to 5% by weight of the soft baked snack,
c) structural protein in an amount of from 5% to 20% by weight of the soft baked snack, and
d) structure setting protein in amount of up to 5% by weight of the soft baked snack, and
where the ratio of the combined collagen amount and hydrolyzed dairy protein amount to the combined structural protein amount and structure setting protein amount is from 1:1 to 1:3;
ii. syrup in an amount of from 15% to 30% by weight of the soft baked snack, the syrup including at least one carbohydrate syrup and glycerin;
iii. dry sugar in an amount of from 5% to 15% by weight of the soft baked snack, where the ratio of the amount of dry sugar to the amount of at least one carbohydrate syrup is from 1:1 to 3:1;
iv. fat in an amount of from 10% to 20% by weight of the soft baked snack; and
b. particulates in an amount of 10% to 35% by weight of the soft baked snack.

2. The soft baked snack of claim 1, wherein the structural protein comprises a soy protein in an amount of up to 12% by weight of the soft baked snack, calcium caseinate in an amount of up to 8% by weight of the soft baked snack, or a combination thereof.

3. The soft baked snack of claim 1, wherein the structure setting protein comprises egg white.

4. The soft baked snack of claim 1, wherein the syrup includes a fiber.

5. The soft baked snack of claim 1, wherein glycerin is included in an amount of from 4% to 15% by weight of the soft baked snack.

6. The soft baked snack of claim 1, wherein the fat comprises a shortening.

7. A method of making a soft baked snack, comprising:
a. providing a dough having a moisture content of from 11% to 22%, and including:
i. protein in an amount of at least 12% by weight of the dough, the protein including:
a) collagen in an amount of from 0.3% to 7% by weight of the dough,
b) hydrolyzed dairy protein in an amount of from 0.3% to 5% by weight of the dough,
c) structural protein in an amount of from 5% to 20% by weight of the dough, and
d) structure setting protein in amount of up to 5% by weight of the dough,
where the ratio of the combined collagen and hydrolyzed dairy protein amounts to the combined structural protein and structure setting protein amounts is from 1:1 to 1:3;
ii. syrup in an amount of from 15% to 30% by weight of the dough, the syrup including at least one carbohydrate syrup and glycerin;
iii. dry sugar in an amount of from 5% to 15% by weight of the dough, where the ratio of the amount of dry sugar to the amount of at least one carbohydrate syrup is from 1:1 to 3:1;
iv. fat in an amount of from 10% to 20% by weight of the dough; and
v. particulates in an amount of 10% to 35% by weight of the dough;
b. forming the dough to produce formed dough; and
c. baking the formed dough to a moisture content of from 7% to 16%.

8. The method of claim 7, further comprising producing the dough using a continuous process.

9. The method of claim 7, wherein the dough is formed by extrusion.
